(19) United States
(12) Patent Application Publication
(10) Pub. No.: US 2013/0071544 A1
(43) Pub. Date: Mar. 21, 2013

(54) Food Products, Seasonings and Processing Methods Thereof

(71) Applicant: Ruben E. Alexander, Mission Viejo, CA (US)

(72) Inventor: Ruben E. Alexander, Mission Viejo, CA (US)

(21) Appl. No.: 13/235,235

(22) Filed: Sep. 16, 2011

(51) Int. Cl. A23L 1/221; A23L 1/315; A23L 1/325; A23L 1/212; A23L 1/31

(52) U.S. Cl. 426/615; 426/641; 426/643; 426/644; 426/650; 426/442

(57) ABSTRACT

The systems and methods described herein relate generally to food processing, and more specifically to commercial processes for preparing foods. A homogeneous liquid seasoning salt composition described herein comprises a diluent, either or both water and oil, salt in concentration range of 1.5%-25% wt, at least one binder, seasoning, and flavoring collectively in concentration range of 1.5%-40% wt, the composition of which is useful as a low cost flavoring for food products while simultaneously providing and/or enhancing juiciness for comestibles. The process for seasoning and preparing of foods described herein comprises the steps of providing a food product seasoned with a liquid seasoning composition, providing a food conveyor to convey the food product through the various steps of the process wherein the food product is seasoned with a liquid salt blend, cooking the food product; and chilling the food product.

### BACKGROUND OF THE INVENTION

1. Field of the Invention

The present invention relates generally to food processing methods and systems, and more specifically to commercial processes for preparing foods. The process begins with a raw or uncooked food product that will be processed using various techniques that include providing seasoning to the food product before it is partially or fully cooked. A variety of battered and unbattered food products may be prepared using one or more embodiments and examples of the disclosed method and apparatus including red meats (e.g., beef, pork and lamb), chicken, poultry, wild game of various kinds, seafood, potatoes, and a variety of other meats, vegetables, and fabricated foods.

2. Background of the Disclosure

Research has shown that obesity is an ever growing epidemic throughout our country among most generations. Most alarming is the exponentially high levels of obesity among our youngest generation. A part of the reason that persons are experiencing unhealthy levels of obesity is due to the fat content in the foods that these persons consume. One culprit that has been identified in the fight against obesity and heart disease is trans fat. Trans fat is made when hydrogen is added to vegetable oil. As the government imposes stricter regulations on the amount of trans-fat that may be included in food products, commercial food product manufacturers are steadily introducing products to the market that include lower and lower levels of trans-fat and other fats. However, the amount of fat included in a food product also impacts the taste and texture of that food product.

Health issues also results from diets high in cholesterol. Most importantly, high blood serum cholesterol levels is a significant risk factor for cardiovascular disease. Cholesterol deposits in the arteries can decrease and even stop blood flow leading to heart attacks. The major source of cholesterol in diets is typically meats, particularly red meat. Cholesterol levels in some popular prepared meats are listed in the table below:

| Meat | Cholesterol(mg/100 g) |
|---|---|
| Fried Ground beef (Lean) | 84 |
| Broiled Beef tenderloin | 84 |
| Broiled Pork tenderloin | 94 |
| Broiled Pork chop | 86 |
| Broiled Lamb shank and tenderloin | 89 |

While lean red meat is offered for sale in many supermarkets, its popularity has not yet reached most restaurants, particularly fast food restaurants. This is so due in part to reduced flavor in lean meats and difficulties in the food preparation process. Therefore there is a need in the art to provide red meat that is low in trans fat and cholesterol while at the same time is flavorful and s many nutrients that we need in our diet. Meat that is trimmed of fat and cooked so that the drippings run off can be part of a balanced diet. People with high blood cholesterol levels should be looking at their total diet and not just the meat portion. Reducing fatty foods from the diet may be just as effective as cutting back on red meat cholesterol.

One method to calculate the fat content in a food product prepared using one or more embodiments of the present invention may be to use the AOAC 960.39 method of testing fat.

Consumers are constantly searching for safer, better tasting and lower fat content foods that require less and less time to prepare from the time of thawing/ordering to the time of consumption. Therefore, there is a need for, commercial food processing companies to provide fast food restaurants and the like with large quantities of several types of par-fried and fully fried food products. These food processing companies must keep up with the tremendous demand in, for example, poultry, in the form of fried chicken, and beef, in the form of hamburgers which will be purchased and consumed by the customers of these restaurants. For example, customers demand the tastiest chicken, which should be hot, moist chicken that is surrounded by a crispy batter and ready to be prepared and ready to be prepared and served almost immediately after ordering. Similarly, customers demand quickly prepared hamburgers that are moist and tasty with a pleasing texture, color and aroma. Typically, these consumers have little time to wait during the preparation of these meals. In general, restaurants are neither afforded the time, the capital, nor the floor space to dedicate an entire process of preparing a fully battered and fried chicken using a raw or uncooked, frozen chicken piece, or a moist and tasty hamburger from a freshly grounded piece of beef and/or turkey each and every time such a meal is ordered. Therefore, there is a need in the art to provide a fully cooked food product that may be stored for subsequent preparation that upon subsequent preparation for consumption is moist and tasty with a pleasing texture, color and aroma.

Concerning unbattered foods and meats such as, for example, hamburgers, sausage, turkey and chicken patties, moisture typically comes from two sources, fat and water. Meats naturally have both of these substances which are, in turn, destroyed by cooking and over-heating. Once sufficient heat is applied to meat, a portion of the fat turns to liquid and runs off. Additionally, the heat causes the muscle fibers in the meat product to contract and force moisture out. The loss of these two substances at higher than acceptable levels causes the meat to dry up and results in an unpleasant experience for the consumer.

Typically, to combat the aforementioned problems, food manufacturers will, among other things, either use foods with a higher fat content and/or add fat and/or water to the meat product before cooking. However, it is this fat content in foods levels that impact the obesity levels and bad blood cholesterol (LDL) while lowering the good cholesterol (HDL) of consumers.

Concerning battered foods, comestibles such as meat, fish and vegetables, frozen comestibles are sold to the food service industry or to the consumer at the retail level to be fully cooked either by baking or frying. However, upon reheating a frozen product, consumers are faced with a food product reminiscent of reheated TV dinners—of the 70's, a soggy which results in, overcooked food product that, if battered, has little or no batter left in tact.

In search for a superior comestible food product, [e.g., hamburger and turkey patties,] a preferred embodiment of the present invention utilizes a liquid seasoning which provides a desirable taste and adds moisture the food product while at the same time allows for substantial reductions of the fat content, cholesterol and trans-fat. For example, the liquid seasonings of the embodiments disclosed herein comprise, for example, a liquid seasoning salt that includes one or more sweeteners (natural and artificial, including but not limited to Splenda, Equal, Stevia, aspartame, sucralose, neotame, sugar alcohols, sugar, sucrose, invert or liquid sugar, corn syrup, fructose) salt and/or salt substitutes, seasonings, herbs and/or flavoring agent, with and without additional binders. Using a liquid seasoning that includes the ingredients of the aforementioned embodiment allows for moisture to be retained in the food product during the heating stage(s). Additionally, preferred embodiments utilize one or more liquid seasonings containing combinations of one or more herbs, seasonings, flavoring agents, salts and/or salt substitutes to help retain the moisture content at acceptable levels when cooking the food product while maintaining and/or enhancing the flavor of the food product to create a multitude of desired flavors.

Preferred embodiments may utilize one or more processes and methods described herein for delivering the liquid seasoning content needed to retain the moisture content in a heated food product, these processes and methods including mixing and/or injecting a liquid seasoning containing one or more herbs, seasonings, flavoring agents, salts and/or salt substitutes into the food product and/or a batter used to prepare the food product.

In the search for a superior battered and un-battered food product, an embodiment provides a process and/or method for providing an end food product that, upon reheating, has a desirable flavor, is visually appealing to the consumer, is both juicy on the inside and having a tasty and pleasing appearance on the outside, all while retains a full complement of batter if utilized. The preexisting processes that begin with a raw or uncooked food product that is subsequently frozen end with an inferior tasting overcooked food product upon re-heating. Furthermore, some of these processes are designed only to process chicken. The present invention will be perceived by those skilled in the art to be easily modified in various ways such as, for example, adjusting the times in which the product is left in the various steps of the process to accommodate many different types of food products. Therefore, the present invention can be used to prepare many different types of food products including, for example, chicken, meat, fish and vegetables.

From the discussion above, it can be seen that there is a need to create a food product that may be cooked frozen for later cooking wherein the fat content may be significantly reduced while at the same time maintaining the juiciness, texture and/or a level of taste that is acceptable to the consumer. There is further a need to provide a process and/or method for producing food products that are flavored, seasoned and pleasing to the food consumer and are safe, easy to prepare, and faster to prepare from the time of thawing/ordering to the time of consumption. There is still a further need for a new and useful process for preparing quality par-fried battered comestible products using processes that are faster, safer, more cost efficient, and that produces comestibles that are more flavorful than conventional products that require higher fat contents or the addition of fat content to ensure a flavorful food product. There is still a further need to provide battered food products that are crisper upon reheating and/or a process that will help to prevent the drying out and over-cooking of a battered food product. There is even still a further need to provide a seasoned food product namely, red meats (e.g., beef, pork, lamb and wild and domesticated wild game), chicken, poultry of various kinds, fish, potatoes, and a variety of other meats, vegetables, and fabricated foods that may be seasoned in a lower cost manner while at the same time maintaining flavor and juiciness when subsequently cooked.

### SUMMARY OF EMBODIMENTS

In accordance with the illustrative embodiments hereinafter described, the preferred homogeneous liquid seasoning salt composition, useful in flavoring food products namely, red meats (e.g., beef, pork, lamb and wild and domesticated wild game), chicken, poultry of various kinds, fish, potatoes, and a variety of other meats, vegetables, and fabricated foods in a lower cost manner while at the same time maintaining flavor and juiciness when subsequently cooked, wherein the liquid within which the salt and flavoring(s) and/or seasoning(s) are dispersed, is either or both oil and water, but most preferably water, wherein the salt concentration is in the range of 1.5 to 25% wt, preferably 1.5-4%, more preferably, >4-12%, and most preferably 12% to 25% of the composition and the flavoring and/or seasoning concentration is in the range of 1.5%-40% wt, preferably 17% to 39%, and most preferably 5% to 15%. The flavorings and seasonings concentrations above have a replacement strength of 1:30. However, embodiments of the flavorings and seasonings may be accordingly made with have a replacement strength in the range of 1:30 to 1:40 if dispersed in water and if dispersed in oil 1:30 to 1:80, further if pure in the range of 1:500 to 1:1000, and one skilled the art will be capable of adjusting the compositions accordingly without departing from the scope of the invention and claims herein. In addition, particularly for ground meats, binders (including sugars and other suitable agents, e.g., in Table 2 below) may be used in the above referenced composition in the range of 1.5 to 45% wt, preferably 1.5-25%, more preferably, 15-35%, and most preferably 30-45% of the composition.

The homogeneous liquid seasoning salt composition according to the above referenced embodiments may be readily used to season and hydrate comestibles by injecting, mixing, immersing or spraying the comestible in all amounts, in the range of 1 to 4 quarts per 100 pounds of comestible, preferably in the range of 1.5 quarts to 2.5 quarts per 100 pounds of comestible, and most preferably 2 quarts per 100 pounds of comestible.

Suitable flavoring and/or seasoning components and methods according to these embodiments may be selected from the group consisting of the flavoring agents listed below in Table 1 as well as compositions disclosed in U.S. Pat. Nos. 4,283,429, 4,315,947, 4,285,981, 4,343,823, 4,877,635, 5,023,017, 5,059,437, 5,061,403, 5,209,870, 6,099,879, 7,037,543, 7,550,162 which are incorporated herein by reference, as well as Vegetone Natural Vegetable Colorants, Oleoresins and Essential Oils, AquaResins, Herbalox Seasoning, Garlic and Onion Extracts, Kalspice and Aquaresin Spice Blends sold by Kalsec Inc., 3713 West Main, P.O. Box 511, Kalamazoo, Mich. 49005-0511; Phone (269) 349-9711 or (800) 323-9320; FAX (269) 382-3060; or on the World Wide Web at Http://www.kalsec.com.

### BRIEF DESCRIPTION OF THE DRAWING

The embodiments and examples described in the Detailed Description section may be understood by reference to the following description taken in conjunction with the accompanying drawings, in which:

FIG. 1 is a flow diagram of a method for preparing food products according to a preferred embodiment of the present invention;

FIG. 2 is a flow diagram of another method for preparing food products according to another embodiment of the present invention including a battering step; and

FIG. 3 is a flow diagram of another method for preparing food products according to another embodiment of the present invention including multiple battering steps.

FIG. 4 is a flow diagram of another method for preparing food products according to another embodiment of the present invention including a mixing and/or regrinding step.

FIG. 5 is a flow diagram of another method for preparing food products according to another embodiment of the present invention including multiple mixing and/or regrinding steps.

FIG. 6 is a flow diagram of a method for preparing and injecting a liquid seasoning salt into a food product according to another embodiment of the present invention.

While certain embodiments of the present invention will be described in connection with the preferred illustrative embodiments shown herein, it will be understood that it is not intended to limit the invention to those embodiments. On the contrary, it is intended to cover all alternatives, modifications, and equivalents, as may be included within the spirit and scope of the invention as defined by the appended claims. In the drawing figures, the same reference numerals are used throughout the description and in the drawing figures for components, elements and processes having like parts and/or steps.

### DETAILED DESCRIPTION OF THE SPECIFIC EMBODIMENTS

The present invention finds application with any comestible that can be seasoned using a liquid seasoning, including poultry, fish, red meats (e.g., beef, pork and lamb), egg products, vegetables, and fabricated foods.

“Egg products”, for these purposes, are any foods derived from eggs of the domestic hen, broken from the shells and then used whole, separated into yolks or whites, dried or frozen. “Fabricated foods” are foods prepared from novel combinations of dietary ingredients and/or processing technology. Examples of fabricated foods include restructured meats and sea-foods, and meat/vegetable/egg based patties.

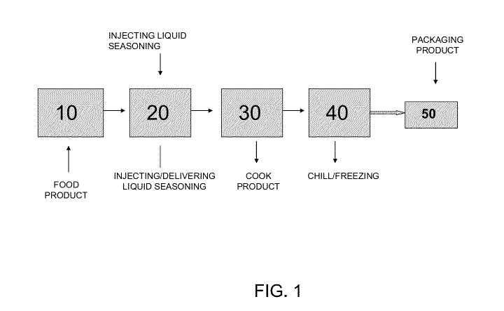

Referring now in detail to the drawing figures, FIG. 1 illustrates a flow diagram of the process of preparing a seasoned food product according to one preferred embodiment of the present invention. Briefly described, in a preferred form, FIG. 1 describes a process and method that produces a seasoned food product. The process described in FIG. 1 preferably includes the following steps:

(a) providing at step 10 a quantity of uncooked food product;
(b) injecting and/or delivering at step 20 a quantity of liquid seasoning into a uncooked food product;
(c) cooking or partially cooking at step 30 the uncooked food product;
(d) chilling and/or freezing at step 40 the cooked or partially cooked food product; and
(e) packaging at step 50 the chilled or frozen food product.

Each of the steps (a)-(e) will now be described in more detail below with reference to FIG. 1.

The raw or uncooked food product provided at step 10 may, for example, consists of poultry, fish, red meats (e.g., beef, pork and lamb), egg products, vegetables, fabricated foods and/or any combination of the aforementioned. The types of food products listed herein is in no way intended to be limiting and is not intended to be or describe a complete list of foods or food products that may be flavored via the injection or delivery step 20 and prepared using the method of FIG. 1 as a complete list is too vast to recite herein. For example, this process may also be used to flavor fibers and various fibrous food products.

At step 20, liquid seasoning is injected directly into or otherwise delivered to the food product. The injection and/or delivery step 20 may be carried out by any industry acceptable food injection apparatus or liquid delivery system that allows for the delivery of a liquid seasoning into a food product. The amount of liquid seasoning used and the number of times that the liquid is injected and/or added to the food product is determined by the desired flavor, quantity and type of food product to be seasoned. Each liquid seasoning preferably includes a liquid (e.g., water) that preferably contains one or more of the following flavoring ingredients: one or more salts and/or salt substitutes, one or more spices, one or more seasonings, one or more herbs, one or more flavoring agents, or a combination of any one or more of the aforementioned. The seasoning, herb, spice, or salt may include, for example, bay leaves, cinnamon, dill, garlic, ginger, mace, mustard, nutmeg, onion powder, sea salt, iodized salt, refined table salt, parsley, peppermint extract, pimiento, rosemary, sage, black pepper, ginger, cloves, cumin, dill, fennel, marjoram, mint, oregano, savory, vanilla, pesto, turmeric, thyme, all spice, basil, salt, spiced salt, saltpeter, plain vinegar, verjuice, lemon and oranges juices, peppercorns, paprika, curry, cayenne, mixed pepper spices sugar, honey, etc. Salt substitutes may include but are not limited to potassium chloride, potassium lactate, etc. A flavoring agent as used herein is an additive that gives a food a particular taste or smell, and is derived from natural ingredients, or created artificially (e.g., or fabricated and/or synthesized). For example, the flavoring agent may include for example, but is not limited to, cheese, meat, alliaceous, tangy, or a combination of flavoring agents. As a complete list of seasonings, herbs, spices, salts and salt substitutes, and flavoring agents that may be included in the liquid seasoning is too large to recite here, the aforementioned list is intended to provide just a few examples of the types of seasonings, herbs, spices, salts and salt substitutes and flavoring agents that may be included in the liquid seasoning that is injected into or otherwise delivered to the raw or uncooked food product. Therefore, the list is intended neither to be limiting nor exhaustive.

TABLE 1
Flavoring Agents

1-Decanol, Natural
1,3-Butylene Glycol
1-Octanol, Natural
1-Octen-3-Yl Acetate
1-Octen-3-Yl Butyrate
10-Undecenal
2,3,5,6-Tetramethylpyrazine
2,3,5-Trimethylpyrazine
2,3-Dimethylpyrazine
2,3-Pentanedione
2,4,5-Trimethylpyrazine-3-Oxazoline
2,5-Dimethylpyrazine
2,5-Dimethypyrrole
2,6-Dimethyl-5-Heptenal
2,6-Dimethylpyrazine
2-Acetylpyrrole
2-Ethyl Fenchol
2-Ethyl-3,5(6)-Dimethylpyrazine
2-Ethyl-3-Methylpyrazine
2-Ethylbutyraldehyde
2-Ethylbutyric Acid
2-Heptanone
2-Methoxy-3(5)-Methylpyrazine
2-Methoxypyrazine
2-Methylbutyl Isovalerate
2-Methylundecanal
2-Pentanone
2-Phenethyl-2-Methylbutyrate
2-Phenylpropionaldehyde
2-Phenylpropionaldehyde Dimethyl Acetal
2-Triidecenal
2-Undecenol
20Butanone
3,7-Dimethyl-1-Octanol
3-Acetyl-2,5-Dimethyl Furan
3-Acetylpyridine
3-Heptanone
3-Octanol
3-Octyl Acetate
3-Phenyl-1-Propanol
3-Phenylpropionaldehyde
3-Phenylpropyl Acetate
4′-Methyl Acetophenone
4-Methyl-2-Pentanone
5′-Guanylic Acid
5′-Inosinic Acid
5-Methyl-2-Isopropyl-2-Hexenal
6-Hydroxy-3,7-Dimethyloctanoic Acid Lactone
6-Methyl Coumarin
6-Methyl-5-Hepten-2-One
Acetaldehyde
Acetanisole
Acetic Acid, Glacial
Acetion Acetophenone
Allyl alpha-Ionone
Allyl Cyclohexanepropionate
Allyl Heptanoate
Allyl Hexanoate
Allyl Isothiocyanate
Allyl Isovalerate
Allyl Tiglate
Almond Oil, Bitter, FFPA
alpha-Amyl Cinnamic Aldehyde
alpha-Amyl Cinnamic Aldehyde Dimethyl Acetal
alpha-Amyl Cinnamyl Alcohol
alpha-Amylcinnamaldehyde
alpha-Hexyl Cinnamic Aldehyde
alpha-Hexylcinnamaldehyde
alpha-Ionone
alpha-Methyl Cinnamic Aldehyde
alpha-Methylbenzyl Alcohol
alpha-Methylcinnamaldehyde
alpha-Phellandrene
alpha-Pinene
alpha-Terpinene
Ambrette Seed Oil
Amyl Acetate
Amyl Cinnamate
Amyl Octanoate
Amyl Propionate
Amyris Oil, West Indian Type
Anethole
Angelica Root Oil
Anise Oil
Anisole
Anisyl Acetate
Anisyl Alcohol
Anisylacetone
Balsam Peru Oil
Basil Oil, Comoros Type
Basil Oil, European Type
Bay Oil
Benzaldehyde
Benzoin Gum
Benzophenone
Benzyl Acetate
Benzyl Bezoate
Benzyl Butyrate
Benzyl Cinnamate
Benzyl Isobutyl Carbinol
Benzyl Isobutyrate
Benzyl Isoeugenyl Ether
Benzyl Isovalerate
Benzyl Phenylacetate
Benzyl Propionate
Benzyl Salicylate
Benzyl Utyl Ether
Bergamot Oil, Expressed
beta-Caryophyllene
beta-Ionone
beta-Pinene
Birch Tar Oil, Rectified
Black Pepper Oil
Bois De Rose Oil
Bornyl Acetate
Brominated Vegetable Oil
Butan-1-Ol
Butan-2-Ol
Butan-3-One-2-Yl Butyrate
Butyl Acetate
Butyl Alcohol
Butyl Butyrate
Butyl Butyryllactate
Butyl Isobutyrate
Butyraldehyde
Butyric Acid
Caffeine
Camphene
Cananga Oil
Caraway Oil
Cardamom Oil
Carrot Seed Oil
Carvacrol
Cascarilla Oil
Cassia Oil
Cedar Leaf Oil
Celery Seed Oil
Chamomile Oil, English Type
Chamomile Oil, German Type
Cinnamaldehyde
Cinnamic Acid
Cinnamon Bark Oil, Ceylon Type
Cinnamon Leaf Oil
Cinnamyl Acetate
Cinnamyl Alcohol, Synthetic
Cinnamyl Anthranilate
Cinnamyl Formate
Cinnamyl Isovalerate
Cinnamyl Propionate
Cis-3-Hexen-1-Ol
Cis-3-Hexenyl 2-Methylbutyrate
Cis-3-Hexenyl Isovalerate
Cis-3-Octen-1-Ol
Cis-4-Hepten-1-Al
Cis-6-Nonen-1-Ol
Citral
Citric Acid
Citronellal
Citronellol
Citronellyl Acetate
Citronellyl Butyrate
Citronellyl Formate
Citronellyl Isobutyrate
Citronellyl Propionate
Clary Oil
Clove Leaf Oil
Clove Oil
Clove Stem Oil
Cognac Oil, Green
Copaiba Oil
Coriander Oil
Costus Root Oil
Cresyl Acetate
Cubeb Oil
Cumin Oil
Cuminic Aldehyde
Cyclamen Aldehyde
D-Carvone
D-Dihydrocarvone
D-Limonene
Decanal
Decanoic Acid
delta-Decalactone
delta-Dodecalactone
Diacetyl
Dibenzyl Ether
Dibutyl Sebacate
Diethyl Malonate
Diethyl Sebacate
Diethyl Succinate
Diethyl Tartrate
Dihydrocarveol
Dihydrocoumarin
Dill Seed Oil, European Type
Dill Seed Oil, Indian Type
Dillweed Oil, American Type
Dimethyl Anthranilate
Dimethyl Benxyl Carbinyl Acetate
Dimethyl Benzyl Carbinol
Dimethyl Benzyl Carbinyl Butyrate
DL-Menthol
DL-Menthyl Acetate
Estragole
Ethyl 2-Methylbutyrate
Ethyl Aacetoacetate
Ethyl Acetate
Ethyl Acrylate
Ethyl Anthranilate
Ethyl Benzoate
Ethyl Butyrate
Ethyl Cinnamate
Ethyl Decanoate
Ethyl Formate
Ethyl Heptanoate
Ethyl Hexanoate
Ethyl Isovalerate
Ethyl Lactate
Ethyl Laurate
Ethyl Maltol
Ethyl Methyl Ketone
Ethyl Methylphenylglycidat
Ethyl Nonanoate
Ethyl Oxyhydrate
Ethyl P-Anisate
Ethyl Phenylacetate
Ethyl Phenylglycidate
Ethyl Propionate
Ethyl Salicylate
Ethyl Vanillin
Eucalyptol
Eucalyptus Oil
Eugenol
Eugenyl Acetate
Eugenyl Methyl Ether
Farnesol
Fennel Oil
Fir Needle Oil, Canadian Type
Fir Needle Oil, Siberian Type
Fumaric Acid
Furfural
gamma-Butyrolcatone
gamma-Heptalactone
gamma-Nonalactone
gamma-Octalactone
gamma-Terpinene
gamma-Undecalactone
gamma-Valerolactone
Geraniol
Geranium Oil, Algerian Type
Gerannyl Benzoate
Geranyl Acetate
Geranyl Acetoacetate
Geranyl Butyrate
Geranyl Formate
Geranyl Phenylacetate
Geranyl Propionate
Ginger Oil
Grapefruit Oil, Coldpressed
Heptanal
Heptyl Alcohol
Hexanal
Hexanoic Aacid
Hexxyl-2-Buutenoate
Hexyl 2-Methylbutyrate
Hexyl Alcohol, Natural
Hexyl Isovalerate
Hops Oil
Hydroxycitronellal
Hydroxycitronellal Dimethyl Acetal
Hydroxycitronellol
Indole
Iso-alpha-Methyl Ionone
Isoamyl Acetate
Isoamyl DBUTYRATE
Isoamyl Formate
Isoamyl Hexanoate
Isoamyl Isovalerate
Isoamyl Salicylate
Isobornyl Acetate
Isobutyl Acetate
Isobutyl Alcohol
Isobutyl Butyrate
Isobutyl Cinnamate
Isobutyl Phenylacetate
Isobutyl Salicylate
Isobutyl-2-Butenoate
Isobutyraldehyde
Isobutyric Acid
Isoeugenol
Isoeugenyl Acetate
Isopropyl Acetate
Isopulegol
Isoquinoline
Isovaleric Acid
Juniper Berries Oil
L-Glutamic Acid Hydrochloride
L-Limonene
L-Menthol
L-Menthone
L-Menthyl Acetate
Labdanum Oil
Laurel Leaf Oil
Lauric Acid
Lauryl Alcohol, Natural
Lauryl Aldehyde
Lavandin Oil, Abrial Type
Lavender Oil
Lemon Oil, Coldpressed
Lemon Oil, Desert Type, Coldpressed
Lemon Oil, Distilled
Lemongrass Oil
Lime Oil, Coldpressed
Lime Oil, Distilled
Linaloe Wood Oil
Linalool
Linalyl Acetate
Linalyl Acetate, Synthetic
Linalyl Benzoate
Linalyl Formate
Linalyl Isobutyrate
Linalyl Propionate
Lovage Oil
Mace Oil
Malic Acid
Maltol
Mandarin Oil, Coldpressed
Marjoram Oil, Spanish Type
Marjoram Oil, Sweet
Mentha Arvensis Oil, Partially Dementholized
Menthol
Methyl 2-Methylbutyrate
Methyl 2-Octynoate
Methyl Anthranilate
Methyl Benzoate
Methyl beta-Naphthyl Ketone
Methyl Cinnamate
Methyl Cyclopentenoione
Methyl Eugenol
Methyl Isoeugenol
Methyl N-Methyl Anthranilate
Methyl Phenylacetate
Methyl Phenylcarbinyl Acetate
Methylbenzyl Acetate
Myrcene
Myristic Acid
Myrrh Oil
Nerol
Nerolidol
Nonanal
Nonyl Acetate
Nonyl Alcohol
Nutmeg Oil
Octanal
Octanoic Acid
Octyl Acetate
Octyl Formate
Oleoresin Black Pepper
Oleoresin Capsicum
Oleoresin Celery
Oleoresin Ginger
Oleoresin Paprika
Oleoresin Turmeric
Olibanum Oil
Onion Oil
Orange Oil, Bitter, Coldpressed
Orange Oil, Coldpressed
Orange Oil, Distilled Origanum Oil, Spanish Type
Orris Root Oil
P-Methoxybenzaldehyde
P-Methyl Anisole
P-Propyl Anisole
P-Propylanisole
P-Tolyl Isobutyrate
Palmarosa Oil
Paprika Oleoresins
Parsley Herb Oil
Parsley Seed Oil
Pennyroyal Oil
Peppermint Oil
Petitgrain Oil, Paraguay Type
Phenethyl Acetate
Phenethyl Alcohol
Phenethyl Isobutyrate
Phenethyl Isovalerate
Phenethyl Phenylacetate
Phenethyl Salicylate
Phenoxyethyl Isobutyrate
Phenylacetaldehyde
Phenylacetaldehyde Dimethyl Acetal
Phenylacetic Acid
Pimenta Leaf Oil
Pimenta Oil
Pine Needle Oil, Dwarf
Pine Needle Oil, Scotch Type
Piperonal
Propenylguaethol
Propionaldehyde
Propionic Acid
Pyrrole
Quinine Hydrochloride
Quinine Sulfate
Rhodinol
Rhodinyl Acetate
Rhodinyl Formate
Rose Oil
Rosemary Oil
Rue Oil
Sage Oil, Dalmatian Type
Sage Oil, Spanish Type
Sandalwood Oil, East Indian Type
Santalol
Santalyl Acetate
Savory Oil (Summer Variety)
Smoke Flavorings
Sodium Chloride
Spearmint Oil
Spice Oleoresins
Spike Lavender Oil
Tangerine Oil, Coldpressed
Tarragon Oil
Terpineol
Terpinyl Acetate
Terpinyl Propionate
Tetrahydrolinalool
Thyme Oil
Trans,Cis-2,6-Nonadienal
Trans,Cis-2,6-Nonadienol
Trans,Trans-2,4-Decadienal
Trans,Trans-2,4-Heptadienal
Trans,Trans-2,4-Nonadienal
Trans-2-Decen-1-Al
Trans-2-Dodecen-1-Al
Trans-2-Hexen-1-Al
Trans-2-Hexen-1-Ol
Trans-2-Nonen-1-Ol
Trans-2-Nonenal
Trans-2-Octen-1-Al
Trans-Anethole
Tributyrin
Turmeric Oleoresin
Undecanal
Undecyl Alcohol
Valeric Acid
Vanillin
Wintergreen Oil

Binders may also be used to thicken or improve the texture and help to maintain uniform texture or consistency throughout the food product. For example, binders may be used in patties or other processed meats to eliminate or minimize breakage during the cooking process. Suitable binders include various forms of sugars, breads, crumbs (cracker, bread, cooked meat, etc.), flour, corn meal and other binders known in the art and listed below in Table 2.

TABLE 2
Binders

Acid Treated Starch
Alkaline Treated Starch
Bleached Starch
Calcium Stearate
Carrageenan
Cellulose, Microcrystalline
Cellulose, Powdered
Dextrin
Dextrins, Roasted Starch
Distarch Phosphate
Ethyl Cellulose
Food Starch, Modified
Glycerin
Hydroxypropyl Distarch Phosphate
Hydroxypropyl Starch
Lactylated Fatty Acid Esters of Glycerol and Propylene
Glycol
Magnesium Stearate
Methylcellulose
Mineral Oil, White
Modified Starches
Monostarch Phosphate
Oleic Acid
Oxidized Starch
Phosphated Distarch Phosphate
Polyethylene Glycols
Sodium Caseinate
Starch Acetate
Starch Sodium Octenylsuccinate
Whey, Dried

For example, the liquid seasoning may contain one or more seasonings, herbs, spices, salts and salt substitutes, and/or flavoring agents that, when tasted in a particular food product, are associated with various ethnic traditional and trendy cuisines such as, by way of example, Asian fusion, Caribbean, Mediterranean, Indian and/or Mexican cuisine. Furthermore, certain seasonings, herbs, spices, salts and salt substitutes, and/or flavoring agents may be mixed the following blended seasonings and/or spices: (1) seasoning salt spice, (2) teriyaki seasoning spice, (4) Cajun spice blend, (5) Jamaican spice blend, (6) Chipolte pepper seasoning blend, (7) Jalapeno pepper seasoning blend, (8) Cuban spice blend, or (9) any combination of the aforementioned. The aforementioned list is in no way meant to be limiting as a list of flavors, blended spices or seasonings that may be produced and injected or dispensed into a food product utilizing an embodiment of the present invention as described in FIG. 1 is too vast to recite here. Seasonings and blended seasonings may be added to a suitable liquid (e.g., water) to create a liquid seasoning, or may be added to a blend of a liquid (e.g., water, vinegar, etc.) to create a liquid seasoning salt. Additionally, one or more spices, herbs, flavoring agents and/or salts may be added to any seasoning, blended seasoning, liquid seasoning or liquid seasoning salt to vary the taste of the same and/or the processed food product.

Referring to the Figures, the cooking step 30 may include steam and/or heat cooking including, but not limited to, dry heat and/or moist heat cooking. For example, the types of cooking that may be employed to cook the food product may include baking, roasting, broiling, sautéing, braising, steaming, poaching, grilling, deep-frying, pan-frying, impingement cooking, simmering, boiling, stewing, simmering, and/or any combination of the aforementioned, etc. The method used to cook the food product in step 30 is in no way intended to be limited to the list recited above and may include other methods of cooking a food product not recited herein. Additionally, the food product may be fully or partially cooked, and/or cooked to any desired temperature. One approach for cooking a food product in step 30 is described in U.S. Pat. No. 6,117,463, entitled “Process For Preparing Battered Foods,” the subject matter of which is hereby incorporated by reference in its entirety.

Once the food product is cooked or partially cooked, the food product is preferably chilled or frozen at step 40. This chilling/freezing step 40 helps the food product to retain its juices and its flavor (the flavor either naturally occurring and/or added by the liquid seasoning in step 20). For example, the food product may be chilled or frozen by any acceptable technique including but not limited to air chilling, water chilling, forced air chilling, flash freezing, etc. One approach for chilling and/or freezing a food product in step 40 is described in U.S. Pat. No. 6,117,463, entitled “Process For Preparing Battered Foods,” the subject matter of which is hereby incorporated by reference in its entirety. Thereafter, the food product may be stored for later consumption. Storing the food product may include packaging 50 the food product in any industry acceptable manner.

Food Product Examples

The following Example is illustrative, but not limiting, of the method for preparing a food product according the preferred embodiment of the present invention. Modification of the embodiments of the present invention described herein according to food preparation techniques, conditions, desired taste, desired texture and/or desired times surrounding preparation and consumption of the food product that are obvious to those of ordinary skill in the art, in view of the present disclosure, are within the spirit and scope of the present invention.

A preferred embodiment of the present invention may be utilized to prepare, by way of example, hamburgers and hamburger patties that have been injected with one or more liquid seasonings and a reduced fat content, when compared to hamburgers and hamburger patties that contain added fat utilized to flavor the hamburger meat.

A ½ lb of grinded raw or uncooked hamburger meat is provided. The hamburger meat may be any type of hamburger meat produced, for example, at a commercial food processing plant, a local farm or butcher shop, by the consumer, and/or sold in your local supermarket. The hamburger meat may be made from any grade of beef including, for example, ground beef, ground chuck, ground sirloin, and/or ground round, or any combination of the aforementioned. Using the process described in one or more embodiments, the fat that is added to raw and uncooked food products using conventional food-product preparation processes for flavoring may be replaced by, for example, liquid seasonings described herein that may be injected and/or mixed into the patty, or added by any other acceptable manner. Using one or more embodiments of the present invention, 80% of the fat may be taken out of food products such as, for example, the traditional hamburger patty and sausage products, and a level of 0% trans fat may be achieved.

Other food products such as battered chicken or chicken fried steak may also be injected with one or more liquid seasonings described herein. Alternatively or in addition to the injection of a liquid seasoning, the batter may also be mixed with one or more of a seasoning, blended seasoning liquid seasoning or liquid seasoning salt described herein. The amount of seasoning, blended seasoning liquid seasoning or liquid seasoning salt that may be mixed with the batter depends upon the quantity and type of food product to be battered and the amount and type of batter used in the battering process.

The approximate cooking times and desired temperatures may vary for different products, such as beef roast, pork roast, ham, chicken parts, fish and many other products. For example, the following temperatures have been associated with certain culinary descriptors of cooking temperatures: Rare (140° F.); Medium-Rare (140° F.); Medium (140° F.); Medium-Well (140° F.); and Well (140° F.). The time for cooking the food product to achieve the desired temperature will Depend upon the method of preparation. For example, a 1-inch thick ½ lb hamburger patty may be grilled for 4 min., 5 min., 6 min., 7 min., or 8 min. to achieve the aforementioned desired temperatures, respectively. However, a pan-broiled hamburger patty may be cooked at 8 min. to achieve a rare temperature, or 12 minutes to achieve a medium temperature. The manner of cooking the food products may include for example oven baking, pan frying, pan broiling, oven broiling, grilling, etc. or any combination of the same. The types of food products, the manner in which they may be cooked, and the desired temperatures are too numerous to list herein. However, one having ordinary skill in the art will understand what temperatures are desired depending upon the food product.

The chilling time may also vary due to the type and amount of the product being prepared by one or more embodiments described herein. The desired temperature for chilling a food product after the step of cooking the product may be around 40° F. and 33° F., and preferably around 34° F. to 36° F. Alternatively, after the food product is cooked at step 30, the food product may be frozen at steps 40, 60 using industry acceptable standards and processed using additional processing steps as described in one or more embodiments of the present invention at a later time.

Seasoning Blend Examples

The following is an example of various types of seasoning blends that may be used with the processes of one or more of the embodiments described herein. The example of seasoning blends may be used, for example, in processes wherein food products are injected with a liquid seasoning. Additionally, the following seasoning blends may be added to brine, culinox, or any other fines salt, and further mixed with water, an amount depending upon the type and amount of food that is being prepared and the taste and level of seasoning desired, to create liquid seasoning salt blends. Furthermore, some of the seasoning ingredients have been described with their accompanying identifiers that may be used to identify and obtain that ingredient from a distributor such as, for example, Skidmore Sales and Distributing. However, these identifiers are in no way meant to narrow the examples of seasonings and liquid seasoning salt blends or their ingredients to any one source, supplier or anything of that nature.

The following example of various types of seasoning blends that may be used with the processes of one or more of the embodiments described herein may be used to marinate all types of food products. In a preferred embodiment, a tumbler used in a commercial food product preparation plant may be used to assist in the marinating of these food products, although smaller food preparatory containers and less lavish methods may be utilized, e.g., in a tub and/or by hand. Examples of seasoning blends and liquid seasonings that may be created using one or more of the ingredients and types of ingredients described above include, but are not limited to, the following:

A preferred embodiment of a water based composition according to the present invention are found below in the following examples:

### Example 1

| Component | Percentage (wt) |
|---|---|
| Natural Flavoring/Seasoning | 5 to 15% |
| Binder | 30 to 45% |
| Polyglycerol Esters of fatty acid | 16 to 26% |
| Mono- and Di-glycerides | 7.35 to 17.35% |
| Propylene Glycol | 7 to 17% |
| Canola Oil | 2 to 6% |
| Salt | 4 to 12% |
| Soy Lecithin | .1 to .2% |
| Water | (as necessary to to bring to 100%) |

### Example 2

| | | |
|---|---|---|
| 1 | ml | Seasoning Spice Code: 22-887719 Lot 4A0176 |
| 3 | ml | Chipotle Pepper Code: 55-993445 Lot 4B0046 |
| 2 | ml | Black Pepper Code: 03-2019 Lot 501549K |
| ½ | ml | Fried Onion Code: 51-12 Lot 8916A |
| 2½ | ml | Fried Garlic Code: 31-08-01 Lot 8819A |
| ½ | ml | Oregano Code: 33-01-19 Lot 8385C |
| 1 | ml | Paprika Code: 02-040-04 Lot 6776H |
| 1 | ml | Sage Code: 41-07-02 Lot 8274C |
| 5 | ml | Sucrose or Invert or Liquid Sugar |
| 11 | oz. | Culinox Water, Brine or Plain Salt Water |

The above referenced Code designations are those of Kalsec, Inc.

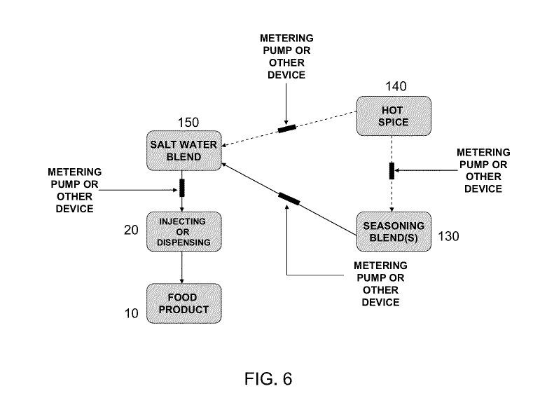

Referring now to FIG. 6, seasoning blends using one or more of the seasonings, herbs, spices, salts and salt substitutes, and/or flavoring agents, or combinations of the same, described above or in the examples recited above, may be utilized to create a liquid salt seasoning that may be used in the injecting/delivering step 20. In the FIG. 6 embodiment, a seasoning or seasoning blend is provided at step 130. Alternatively, an additional seasoning such as a hot spice may be added to the seasoning or seasoning blend at step 140 to give the seasoning or seasoning blend a hot, spicy or pepper flavoring. In this instance, a spice or heat simulating seasoning or herb such as Capsicum or Cayenne may be utilized. Common names and varieties for these Capsicum and Cayenne spices include, but are not limited to, cayenne, cayenne pepper, chili pepper, paprika, peepers, pimiento, red pepper, sweet pepper, aji dulce, Hungarian pepper, and Mexican pepper. The amount of hot spice added will depend upon the user's desired flavoring and/or heat unit. At step 150, a salt water mixture is added to the seasoning or seasoning blend and combined in such a manner (e.g., mixing) to produce a liquid seasoning salt. The amount of salt water and the type of salt or salts used may vary depending upon the desired taste and the amount of seasoning or seasoning blend provided in step 130. For example, eleven (11) ounces of culinox water, brine or plain salt water was used in the above provided seasoning blends to for the amounts of seasonings described to make a liquid seasoning salt blend. As described in FIG. 6, metering pumps or other devices (e.g., container, spoon, injectors, conveyors, etc.) may be used to transfer the different the liquid seasoning salt itself and/or the ingredients used to produce a liquid seasoning salt, and blenders and/or mixers of various types, depending upon the amount of liquid seasoning salt to be prepared and the type of process used to prepare the same, may be utilized in the process to blend and/or mix the same. These same metering pumps and/or other devices or variations of the same may also be used to transfer the liquid seasoning salt prepared by the method of FIG. 6 to an injector and/or dispenser such that the liquid seasoning salt may be injected into the food product(s) or dispensed into a batter at step 20, as described in FIGS. 1-5 and described herein.

Alternatively, a seasoning, blended seasoning, liquid seasoning, and/or liquid salt seasoning may be used as a rub or marination for meat products such as, for example, ribs, beef roast, ham pork roast, chicken, lamb turkey and many other products. The rub or marination may be added to a meat or other food product using a brush, small mop, hand rub, tumbler or other suitable device or method. One example of a rub and/or marination that may be utilized using a liquid seasoning is the following:

### Example 3

### Liquid Seasoning (RUB) Marination

| | |
|---|---|
| 1 ml | Tenderizer |
| 2 ml | Seasoning Spice |
| 3 ml | Fried Garlic |
| 2 ml | Fried Onion |
| 3 ml | Aquaresin Paprika Durabrite |
| 3 ml | Liquid Sugar |

Seasonings or blended seasonings such as, for example, Cuban, Chipolte Jalapeno pepper, and Jamaican, may be added to the Liquid Seasoning (RUB) Marination formula above in quantities that vary with the user's desired taste. For example, a preferred embodiment uses 3 ml of a blended seasoning may be added to the Liquid Seasoning (RUB) Marination formula above extended to accommodate the quantity and type of meat to be processed as previously described. For example, an embodiment of the present invention may use the following formulas to prepare food products using a liquid seasoning salt: (1) 2 quarts of water to 17 ozs. of salt; (2) 12 ml of spices to 11 ozs. of salt water (e.g., Culinox water, Brine or other salt water); (3) or 10 ml of seasoning or a seasoning blend to ½ pound of meat. Furthermore, these formulas may be changed depending upon the type of food product and the desired flavor, and may be extended depending upon the amount of food product being prepared.

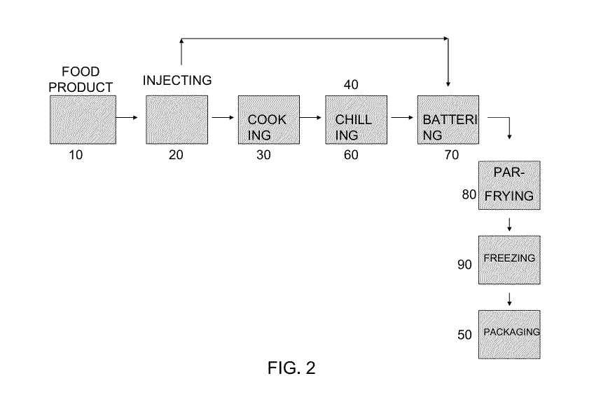

Several variations of the above process and method described in FIG. 1 exist in other preferred embodiments. For example, as shown in FIG. 2, the step 40 of chilling and/or freezing a food product may be limited to chilling the food product. This chilling step 40 prevents the food product from over-cooking, helps the product retain its juices, and keeps the batter from the following battering step 50 (described below) from becoming tough and chewy. In conventional processes without a chilling step, the juices begin to flow out of the product before the product is battered. In the preferred method of FIG. 2, the food product is chilled so it does not lose its juices during the period of time from exiting the chilling step 40 to entering the par-frying step 80 (discussed below). As an alternative to the chiller, the food product can be immersed in a vat of chilled water. Yet this immersion into cool water is not preferred because chilled water draws juices out of the product 10. Cooling the product before the battering step 70 also provides for both better batter adherence to the food, and produces the desirable feathering of the batter on the product. This better adherence again helps retain the juices in the food and produces a crispy (not chewy) batter. If the product is not chilled before battering 70, the food product continues to cook through the battering step 50 due to retained heat in the product, and thus the batter becomes very tough and chewy. Further, if the food product is not cooled, the batter lies flat on the product, not the preferred feathered/wrinkled texture, giving it an unappealing look and texture. One approach for chilling a food product in step 40 is described in U.S. Pat. No. 6,117,463, entitled “Process For Preparing Battered Foods,” the subject matter of which is hereby incorporated by reference in its entirety.

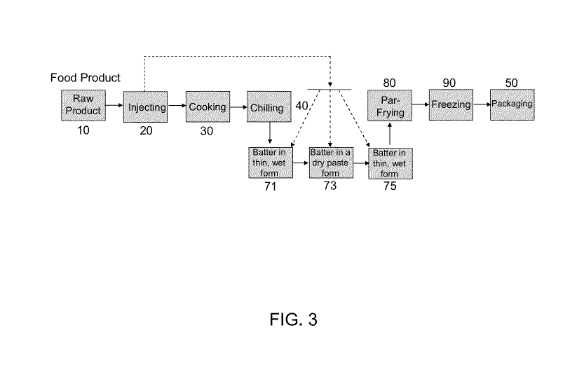

The battering step 70 described in FIGS. 2 & 3 includes either applying a single coating of batter to the food product or, preferably, includes three battering substeps wherein 3 coatings of the same or different coatings of batter are applied to the food product. For example, as described in FIG. 3, the product is battered 71 using a thin, wet batter, dusted 73 and battered 75 again before proceeding to the par-frying step 80.

In a preferred embodiment, the food product is immersed in step 71 into an all-purpose battering machine that is filled with a thin batter wash. In a preferred embodiment, this batter wash comprises 70% to 86% water with a 30% to 14% compliment of dry batter. The food product then proceeds to the second substep 73 of the three step batter method 70, which second step 73 comprises coating the food product with a dry coating of the same batter. Dry coating the food product can be applied with, for example, the Stein XL three flip coater that allows the product to be fully coated while any excess of dry coating is removed. Utilizing the first two substeps 71, 73 of the battering step 70 provides a coated food product with fewer surface voids than products made by conventional battering processes. The dry dust adheres to the thin batter wash better than it does on an uncoated product.

Continuing the preferred battering process described in FIG. 3, the third substep 75 applies a coating comprising a thicker, wet batter to the food product by the same type of batter applicator that was used for the first substep 71 batter wash. The thicker batter preferably comprises 60% to 75% water with 40% to 25% dry batter, depending on the amount of weight desired for the final batter coating. Applying this third coating seals the product and provides a moist, crisp premium product.

After the three substep battering coating process 71, 73 and 75, the product 10 then proceeds to a frying step 80. The fryer is preferably filled with pure vegetable oil and is preferably configured to continuously filter the oil. Typically, if the oil is not filtered, there exists a burnt taste that comes from sediments left in the oil. The food product is fried, preferably for two (2) to 4½ (4.5) minutes. The time for frying the food product may vary depending upon the type of food product being prepared, the size of the food product, and the time in which it takes to par-fry the batter coating. This step 80 allows the final product to be baked or fried without drying out the fully cooked product. In this step 80, the batter on the product is cooked to a beautiful golden color, while the food product inside the coating is fully warmed without losing a substantial amount of its juices. While the frying step can fully cook the batter, instead of par-frying, using conventional processes will leave the consumer with a very dry, and tasteless product. The product should remain on the conveyor belt long enough so that any excess oil drips off or are otherwise removed before the product reaches the freezing step 70.

Lastly, the food product may be frozen at step 90 and readied for packaging 50 and possibly shipping if the food product cannot not be prepared for serving within an acceptable amount of time determined by industry standards and conventional practice.

The present battering step 70 may preferably comprise the use of a single type of batter that not only is cost effective, but also produces a superior battered product. The first substep 71 preferably includes applying the batter in a thin wet form, instead of using a milk wash used in conventional processes. The second substep 73 preferably includes applying the same batter as a dry dusting, instead of the additional expense of purchasing breadcrumbs. The third substep 75 preferably includes applying the batter in a thicker wet form for the last coating, where other manufacturing processes require the purchase of a tempura batter. Further, the present battering step 70 preferably uses a batter component comprising only water and dry batter. This composition preferably does not mix any milk products that can lead to contamination if spoiled. Although all of the battering steps discussed by way of example above may utilize the same type of batter, it is within the scope and spirit of the present invention to utilize one or more different types of batter to practice the invention and, thus, it is not intended for the invention to be limited to the preferred embodiment as discussed herein. One approach for battering a food product in step 70 is described in U.S. Pat. No. 6,117,463, entitled “Process For Preparing Battered Foods,” the subject matter of which is hereby incorporated by reference in its entirety.

In a preferred embodiment of the present invention, the various components of the system of the present invention, preferably comprises the following components:

A MEPSCO Poultry Water Injector, preferably the BI-244 injector for boneless products, chicken fillets and other boneless products. The BI-244L water injector has extra high clearance for handling bone-in chicken and other bone-in products. It produces maximum yields on 31½″ wide bed with production rates up to 15,000 lbs./hr.;

A STEIN GYRoCOMPACT High Steam and Heat Cooker which forms a self-contained cooking chamber. The entire stack turns as a unit while hot air and steam are vertically directed at the product. While this cooker can cook with dry heat, steam alone, or a combination of heat and steam, it is preferably to cook with the combination because if only steam alone is used, the final product will have a tendency to lose its firmness and texture.

A STEIN GYRoCOMPACT Chiller is preferred to chill the product as it comes from the steam and heat cooker, although other industry acceptable chillers may be utilized;

An ABC-III Batter Applicator may be used for applying the thin coat of batter which helps in the pick-up of the dry dusting application, although other industry acceptable batter applicators may be utilized;

The dry coating may be applied by the ABC XL 3 Flip Coater allowing the product to be fully coated and the excess of the dry coating to be removed leaving no voids on the surface of the product, although other industry acceptable dry coating machines may be utilized;

The third coating of a thicker wet batter may be applied, for example, by an ABC-II Batter Applicator, although other industry acceptable batter applicators may be utilized. Applying this coating seals the product and produces a crisper product and does not allow the juices to escape from the product.

For example, a STEIN TFF-II THERMOFIN Fryer may be used to par fry long enough to seal the batter application to retain its juices, although other industry acceptable fryers may be utilized; and

Lastly, when the food product leaves the fryer, it may proceed, for example, directly to a GYRoCOMPACT Freezer where it is frozen and readied for packaging, although other industry acceptable freezers may be utilized.

One approach for battering a food product in step 70 and a system for transporting the food product through the various cooking, chilling, battering par-frying, freezing and packaging steps described in one preferred embodiment of the present invention is described in U.S. Pat. No. 6,117,463, entitled “Process For Preparing Battered Foods,” the subject matter of which is hereby incorporated by reference in its entirety. Additionally, an example of a product that may be utilized to inject the liquid seasoning into a food product is a hand brine pump such as the #MC0051 metered pump provided by The Home Processor Co. in Gainsville, Ga., or the YUANCHANG automatic commercial saline meat injector (Model No. ZSI-140) provided by Hebie Yuanchang Food Mechanism & Technology Co., Ltd. [Hebei, China (Mainland)].

The processes described in FIGS. 2 & 3 fully cook the product in the steam and/or heat cooker (thereafter only requiring reheating to cook the par-fried battered and warm the product), killing all troublesome bacteria (i.e., salmonella) and preferably utilizes a three substep battering process which uses the same batter product throughout, although a single battering step may be utilized.

In another preferred embodiment of the present invention as described in FIGS. 2 & 3, the liquid seasoning may also be injected or dispensed by a suitable mechanism, (e.g., metering pump, spoon, container), into the wet batter such that the batter may be seasoned to the desired taste.

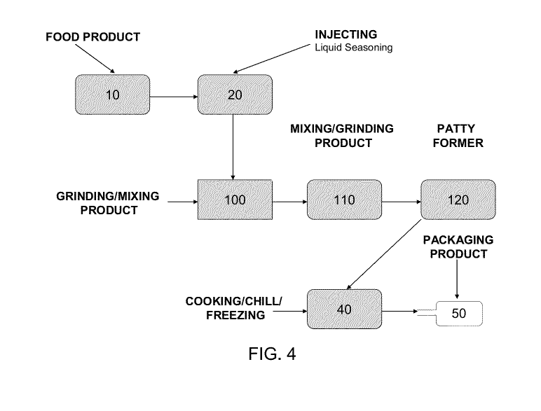

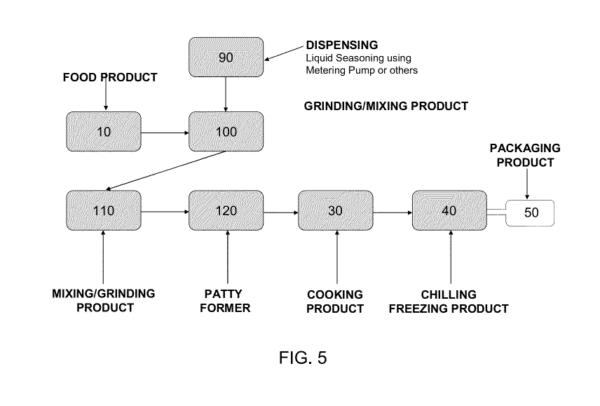

Other variations of the above process and method described in FIGS. 1-3 exist in other preferred embodiments. For example, as shown in FIGS. 4 AND 5, the step 100 of grinding and/or mixing a food product after the food product has been injected with or otherwise combined with the liquid seasoning may be employed. For example, once a quantity of hamburger meat is obtained and injected or combined with liquid seasoning (e.g., 1/2 lb of ground beef), the hamburger meat may be grinded and/or mixed such that the liquid seasoning is further dispersed in therein. Although hamburger meat is used as an example, any food product that may be grinded and/or mixed may be processed via the step 100.

It may be desirable at the grinding and/or mixing step 100 to either mix in one or more additional flavoring ingredients with the food product. For example, at the grinding and/or mixing step 100, it may be desirable to mix hamburger meat with one or more vegetables to include onions, green peppers, minced garlic, etc. Grinding and/or mixing additional flavoring ingredients with the food product at step 100 ensures that the liquid seasoning will also be dispersed within the combination of the food product and one or more of the additional flavoring ingredients that were added. The aforementioned one or more additional flavoring ingredients may include but are not limited to one or more seasonings, herbs, spices, salts and salt substitutes, and/or flavoring agents, one or more food products as described above, or any combination of the aforementioned. Of course, it is within the spirit of the present invention to perform the grinding and/or mixing step 100 before or after the injecting or delivery step 20, depending upon the desired outcome.

After the grinding and/or mixing step 100, the food product may again be grinded (regrinded) and/or mixed 110 such that (1) the subparts, pieces and/or particles of the food product that were produced by the first grinding and/or mixing step 100 may be made smaller in weight or in size than what was obtained from the first grinding and/or mixing step 100, (2) the liquid seasoning is further dispersed within the food product, and/or (3) the ingredients that are included in the food product are further dispersed within the food product. In another preferred embodiment of the present invention, one or more additional ingredients may be added to the food product in the mixing and/or regrinding step 110 such that the liquid seasoning is dispersed in the composite food product. Although not shown, it is in the spirit of the invention to add an additional injection or delivery step 20 before or after the grinding and/or mixing step 110 such that one or more additional liquid seasonings may be added to the food product.

Additionally, as described in FIGS. 4 & 5, the mixed and grinded food product may be fashioned into a patty by a patty former 120. The patty former may be configured to make food product patties (e.g., hamburger patties) of a specific weight, size, and or shape, depending upon the needs of the consumer. The grinded food product may also be fashioned to make a sausage. In this instance, the food product may include beef, poultry, lamb, turkey and many other meat products or combination of the same. The grinded meat may be shaped by a meat former or made into a slurry, and stuffed into a sausage casing using a suitable stuffer.

Still other variations of the present invention are described in FIG. 5 wherein the liquid seasoning is dispensed at step 20 before, during or after the first grinding and/or mixing at step 100 such that the liquid seasoning is mixed into the food product. In a preferred embodiment, a metering pump or other apparatus that may dispense a desired amount of the liquid seasoning may be utilized in the process. Additionally, although not described in FIG. 5, the liquid seasoning may also (1) be dispensed at step 20 a single time, after the mixing and/or regrinding at step 110, or (2) be dispensed for a second time before or after the mixing and/or regrinding at step 110 depending upon the desired outcome. In this example, the liquid seasoning that was dispensed for the second time may be of the same composition or a different composition than the liquid seasoning that was dispensed at step 20 the first time. Additionally, the liquid seasonings and/or blended seasonings of the present invention may be used for different flavorings in beverages such as, for example, coffee, tea and many other beverages. Further, the liquid seasonings of the present invention may be dehydrated using, for example, blending salt or flour to create a blended seasoning or seasoning.

Specific embodiments of the present invention have been described and illustrated. It will be understood to those skilled in the art that changes and modifications may be made without departing from the spirit and scope of the inventions defined by the appended claims.

1.-10. (canceled)

11. A process for seasoning and preparing of foods comprising the steps of:
(a) providing a quantity of food product wherein said food product is seasoned with a liquid seasoning composition, said liquid seasoning composition comprising salt, at least one binder, seasoning, and flavoring;
(b) providing a food conveyor to convey the food product through the various steps of the process wherein the food product is seasoned with a liquid salt blend;
(c) cooking the food product; and
(d) chilling the food product.

12. The process according to claim 11, comprising the further step of injecting the food product with liquid flavoring solution before the steam and heat-cooking step (c).

13. The process of preparing foods according to claim 12, comprising the step of freezing the food product.

14. The process according to claim 13, wherein the flavoring is selected from the group consisting of the flavorings in Table 1.

15. The process according to claim 14, wherein the food product is fully cooked upon exiting the step (c) the food product cooking.

16. The process according to claim 11, wherein said liquid seasoning salt composition comprises salt in the range of 1.5-25% of the composition.

17. The process according to claim 16, wherein said liquid seasoning salt composition comprises a binder in the range of 1.5-45% of the composition.

18. The process according to claim 17, wherein said liquid seasoning salt composition comprises seasoning in the range of 1.5-40% of the composition.

19. The process according to claim 18, wherein said liquid seasoning salt composition comprises flavoring in the range of 1.5-40% of the composition.

20. The process according to claim 19, wherein said food product is selected from the group consisting of beef, pork, lamb, chicken, poultry, wild game, seafood, vegetables and fabricated foods.

21. The process for preparing foods comprising the steps of:
(a) providing a quantity of raw food product;
(b) providing a food conveyor to convey the raw food product through the various steps of the process;
(c) injecting the food product with a liquid seasoning composition, said liquid seasoning composition comprising salt, at least one binder, seasoning, and flavoring;
(d) steam and heat-cooking the raw food product until the raw food product is fully cooked;
(e) chilling the food product, which chilling step both chills the food product so that it does not continue to cook, and cools down the food product; and
(f) freezing the food product.

22. The process according to claim 21, wherein said liquid seasoning salt composition comprises salt in the range of 1.5-25% of the composition.

23. The process according to claim 22, wherein said liquid seasoning salt composition comprises a binder in the range of 1.5-45% of the composition.

24. The process according to claim 23, wherein said liquid seasoning salt composition comprises seasoning in the range of 1.5-40% of the composition.

25. The process according to claim 24, wherein said liquid seasoning salt composition comprises flavoring in the range of 1.5-40% of the composition.

26. The process according to claim 25, wherein said food product is selected from the group consisting of beef, pork, lamb, chicken, poultry, wild game, seafood, vegetables and fabricated foods.
